(19) United States
(12) Patent Application Publication
(10) Pub. No.: US 2004/0030525 A1
(43) Pub. Date: Feb. 12, 2004

(54) Method and system for identifying high-quality items

(76) Inventors: Gary Robinson, Bangor, ME (US); Robert Swerdlow, Falmouth, ME (US); Matt Goyer, Waterloo (CA)

Correspondence Address: ELMAN TECHNOLOGY LAW, P.C., P O BOX 209, SWARTHMORE, PA, 19081-0209, US

(21) Appl. No.: 10/325,693

(22) Filed: Dec. 19, 2002

Related U.S. Application Data
(63) Continuation-in-part of application No. 10/274,850, filed on Oct. 18, 2002, now abandoned.
(60) Provisional application No. 60/345,548, filed on Oct. 18, 2001.

(30) Foreign Application Priority Data
Oct. 18, 2002 (WO) PCT/US02/33512

(51) Int. Cl. G01D 1/00; G06M 11/04; G06F 15/00

(52) U.S. Cl. 702/127

(57) ABSTRACT

A network-based computer system that organizes representations of information provided by users known as Deeds, wherein Deeds represent different versions of the same document, which includes communication such that a Topic may have a plurality of associated Deeds. The system provides any of a plurality of users the ability to create a new Deed by cloning, during which selected data is inherited from an existing Deed. The system provides a plurality of users with the ability to rate Deeds, at any point in time. One Deed associated with a given Topic is considered to be the Current Best. The system makes the Current Best more readily viewable than other Deeds associated with the Topic. The system combines expressions of opinion of a plurality of users to determine the Current Best.

### CROSS-REFERENCE TO RELATED APPLICATIONS

This is a continuation-in-part of U.S. patent application Ser. No. 10/274,850 filed Oct. 18, 2002, which application claims priority from U.S. provisional patent application No. 60/345,548, filed Oct. 18, 2001, the disclosure of each being hereby incorporated herein by reference. The disclosure of International Patent Application PCT/US02/33512, filed Oct. 18, 2001, is also incorporated herein by reference.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever.

### COMPUTER PROGRAM LISTING APPENDIX STATEMENT

See the computer program listing appendix filed herewith and filed with the aforementioned U.S. patent applications, all of which are incorporated by reference herein.

Copyright©2001, 2002 Transpose, LLC

The following files are on the duplicate disks submitted herewith and are hereby incorporated by reference:

./transpose:
total 4

| | | | |
|---|---|---|---|
| drwxr-xr-x | 10 bob | 4096 | Oct 18 15:02 songsifter |

./transpose/songsifter:
total 112

| | | | |
|---|---|---|---|
| -rw-r--r-- | 1 bob | 1211 | Mar 1 2002 Makefile |
| drwxr-xr-x | 5 bob | 0 | Oct 18 15:01 WEB-INF |
| drwxr-xr-x | 2 bob | 4096 | Oct 18 15:01 adminjsps |
| -rw-r--r-- | 1 bob | 1808 | Jul 16 17:26 build.xml |
| drwxr-xr-x | 2 bob | 4096 | Oct 18 15:01 database |
| drwxr-xr-x | 2 bob | 40960 | Oct 18 15:01 images |
| drwxr-xr-x | 3 bob | 0 | Oct 18 15:01 java |
| drwxr-xr-x | 3 bob | 61440 | Oct 18 15:01 jsps |
| drwxr-xr-x | 2 bob | 0 | Oct 18 15:01 logs |
| drwxr-xr-x | 3 bob | 0 | Oct 18 15:06 mathjsps |

./transpose/songsifter/WEB-INF:
total 14

| | | | |
|---|---|---|---|
| drwxr-xr-x | 2 bob | 0 | Oct 18 15:01 conf |
| drwxr-xr-x | 2 bob | 8192 | Oct 18 15:01 lib |
| drwxr-xr-x | 2 bob | 0 | Oct 18 15:01 tlds |
| -rw-r--r-- | 1 bob | 5337 | Jul 16 16:50 web.xml |

./transpose/songsifter/WEB-INF/conf:
total 38

| | | | |
|---|---|---|---|
| -rw-r--r-- | 1 bob | 38166 | Aug 8 20:35 |
| | | | TurbineResources.properties |

./transpose/songsifter/WEB-INF/lib:
total 5153

| | | | |
|---|---|---|---|
| -rw-r--r-- | 1 bob | 45386 | Aug 30 2001 activation-1.0.1.jar |
| -rw-r--r-- | 1 bob | 379658 | Aug 30 2001 ecs-1.4.1.jar |
| -rw-r--r-- | 1 bob | 175666 | Aug 30 2001 hsql.jar |
| -rw-r--r-- | 1 bob | 76964 | Aug 30 2001 httpunit.jar |
| -rw-r--r-- | 1 bob | 236041 | Aug 30 2001 idb.jar |
| -rw-r--r-- | 1 bob | 29937 | Aug 30 2001 jakarta-regexp-1.3-dev.jar |
| -rw-r--r-- | 1 bob | 89492 | Feb 7 2002 jblogger-0.3.jar |
| -rw-r--r-- | 1 bob | 84854 | Aug 30 2001 jdbc-se2.0.jar |
| -rw-r--r-- | 1 bob | 6727 | Aug 30 2001 jdbc2_0-stdext.jar |
| -rw-r--r-- | 1 bob | 98496 | Aug 30 2001 jndi-1.2.1.jar |
| -rw-r--r-- | 1 bob | 17619 | Aug 30 2001 jta1.0.1.jar |
| -rw-r--r-- | 1 bob | 97382 | Aug 30 2001 junit-3.2.jar |
| -rw-r--r-- | 1 bob | 152037 | Aug 30 2001 log4j-1.1.jar |
| -rw-r--r-- | 1 bob | 280984 | Aug 30 2001 mail-1.2.jar |
| -rw-r--r-- | 1 bob | 9549 | Nov 13 2001 mailet.jar |
| -rw-r--r-- | 1 bob | 109927 | Aug 30 2001 mm.mysql-2.0.4.jar |
| -rw-r--r-- | 1 bob | 76734 | Aug 30 2001 oro.jar |
| -rw-r--r-- | 1 bob | 194500 | Aug 30 2001 postgresql.jar |
| -rw-r--r-- | 1 bob | 208635 | Aug 30 2001 sapdbc.jar |
| -rw-r--r-- | 1 bob | 701566 | Oct 22 2001 turbine-2.2b1.jar |
| -rw-r--r-- | 1 bob | 369494 | Aug 30 2001 velocity-1.2-dev.jar |
| -rw-r--r-- | 1 bob | 30922 | Oct 22 2001 village-1.5.3-dev.jar |
| -rw-r--r-- | 1 bob | 199644 | Oct 22 2001 webmacro-0.94.jar |
| -rw-r--r-- | 1 bob | 702536 | Oct 22 2001 xalan-2.0.0.jar |
| -rw-r--r-- | 1 bob | 840704 | Aug 30 2001 xerces-1.3.0.jar |
| -rw-r--r-- | 1 bob | 47926 | Aug 30 2001 xmlrpc.jar |

./transpose/songsifter/WEB-INF/tlds:
total 13

| | | | |
|---|---|---|---|
| -rw-r--r-- | 1 bob | 12439 | May 29 13:20 taglib.tld |

./transpose/songsifter/adminjsps:
total 25

| | | | |
|---|---|---|---|
| -rw-r--r-- | 1 bob | 6781 | Jul 2 13:05 createcdauction.jsp |
| -rw-r--r-- | 1 bob | 440 | Mar 5 2002 createtestscheduledtask.jsp |
| -rw-r--r-- | 1 bob | 1141 | Jul 16 16:52 mailinglistsubscribers.jsp |
| -rw-r--r-- | 1 bob | 8176 | Mar 15 2002 scheduledjobs.jsp |
| -rw-r--r-- | 1 bob | 665 | Jul 16 16:52 sendnewsletter.jsp |
| -rw-r--r-- | 1 bob | 5988 | Jul 2 13:05 topscorers.jsp |

./transpose/songsifter/database:
total 54

| | | | |
|---|---|---|---|
| -rw-r--r-- | 1 bob | 13853 | Aug 28 17:12 DemoSchema.sql |
| -rw-r--r-- | 1 bob | 5377 | May 6 14:51 MusicNewsSchema.sql |
| -rw-r--r-- | 1 bob | 702 | Mar 11 2002 NewsSchema.sql |
| -rw-r--r-- | 1 bob | 1906 | Mar 27 2002 OracleClearData.sql |
| -rw-r--r-- | 1 bob | 3829 | Mar 29 2002 OracleInitValues.sql |
| -rw-r--r-- | 1 bob | 364 | Apr 19 16:04 OracleJDBCUser.sql |
| -rw-r--r-- | 1 bob | 16068 | Sep 4 14:59 OracleSchema.sql |
| -rw-r--r-- | 1 bob | 440 | Dec 5 2001 OracleUser.sql |
| -rw-r--r-- | 1 bob | 625 | Apr 21 10:16 RepairCTXIndexes.sql |
| -rw-r--r-- | 1 bob | 5450 | May 6 14:51 SuggestionSchema.sql |
| -rw-r--r-- | 1 bob | 214 | Apr 18 2002 oraclecommands.txt |
| -rw-r--r-- | 1 bob | 340 | Jul 22 17:16 savepoints.sql |

./transpose/songsifter/images:
total 255

| | | | |
|---|---|---|---|
| -rw-r--r-- | 1 bob | 1941 | Jan 31 2002 EM_badge.gif |
| -rw-r--r-- | 1 bob | 1861 | Apr 23 16:39 EM_badge_0.gif |
| -rw-r--r-- | 1 bob | 728 | Apr 23 16:39 EM_badge_1.gif |
| -rw-r--r-- | 1 bob | 732 | Apr 23 16:39 EM_badge_2.gif |
| -rw-r--r-- | 1 bob | 727 | Sep 4 14:59 EM_badge_4.gif |
| -rw-r--r-- | 1 bob | 4591 | Feb 8 2002 EM_logo_black_bg.gif |
| -rw-r--r-- | 1 bob | 698 | May 20 14:10 EM_rate_my_em.gif |
| -rw-r--r-- | 1 bob | 691 | May 20 14:10 EM_rate_our_em.gif |
| -rw-r--r-- | 1 bob | 784 | Apr 4 2002 amazon.gif |
| -rw-r--r-- | 1 bob | 90 | Aug 10 2001 arror.gif |
| -rw-r--r-- | 1 bob | 1079 | Nov 15 2001 |
| | | | bg_eurosynth_footerredshad.jpg |
| -rw-r--r-- | 1 bob | 1018 | Nov 15 2001 |
| | | | bg_eurosynth_footershadow.jpg |
| -rw-r--r-- | 1 bob | 975 | Nov 15 2001 |
| | | | bg_eurosynth_medshadow.jpg |
| -rw-r--r-- | 1 bob | 1079 | Dec 11 2001 bg_footer_hilite.jpg |
| -rw-r--r-- | 1 bob | 975 | Dec 11 2001 bg_footer_shadow.jpg |
| -rw-r--r-- | 1 bob | 102 | Dec 11 2001 bg_header_separator.gif |
| -rw-r--r-- | 1 bob | 1282 | Dec 11 2001 bg_header_shadow.jpg |
| -rw-r--r-- | 1 bob | 148 | Nov 15 2001 blank.gif |
| -rw-r--r-- | 1 bob | 599 | Apr 26 11:06 bug_bang.gif |
| -rw-r--r-- | 1 bob | 645 | Nov 15 2001 bug_help.gif |
| -rw-r--r-- | 1 bob | 394 | Nov 15 2001 bug_more.gif |
| -rw-r--r-- | 1 bob | 105 | Nov 15 2001 bug_music.gif |
| -rw-r--r-- | 1 bob | 613 | Nov 15 2001 bug_new.gif |
| -rw-r--r-- | 1 bob | 521 | Nov 15 2001 bug_news.gif |
| -rw-r--r-- | 1 bob | 467 | Apr 4 2002 buy.gif |
| -rw-r--r-- | 1 bob | 71 | Sep 13 2001 childline.gif |
| -rw-r--r-- | 1 bob | 208 | Oct 19 2001 circleHelp1.gif |
| -rw-r--r-- | 1 bob | 204 | Oct 19 2001 circleMore1.gif |
| -rw-r--r-- | 1 bob | 127 | Sep 13 2001 deed.gif |
| -rw-r--r-- | 1 bob | 819 | Jul 31 2001 dnarrow.gif |
| -rw-r--r-- | 1 bob | 177 | Jul 31 2001 downtrend.gif |
| -rw-r--r-- | 1 bob | 5229 | Nov 15 2001 em_eurosynth_med.gif |
| -rw-r--r-- | 1 bob | 5229 | Dec 4 2001 em_logo.gif |
| -rw-r--r-- | 1 bob | 94600 | Mar 19 2002 foosballtable.jpg |
| -rw-r--r-- | 1 bob | 184 | Jul 31 2001 help.gif |
| -rw-r--r-- | 1 bob | 27035 | Feb 8 2002 listening.jpg |
| -rw-r--r-- | 1 bob | 2513 | Feb 8 2002 listening_small.jpg |
| -rw-r--r-- | 1 bob | 1804 | Jul 31 2001 logo.gif |
| -rw-r--r-- | 1 bob | 698 | Sep 4 14:59 m3u.gif |
| -rw-r--r-- | 1 bob | 734 | Apr 4 2002 mp3.com.gif |
| -rw-r--r-- | 1 bob | 467 | Apr 3 2002 mp3.gif |
| -rw-r--r-- | 1 bob | 1547 | Jul 31 2001 musicbox.gif |
| -rw-r--r-- | 1 bob | 379 | Mar 22 2002 needsrating.gif |
| -rw-r--r-- | 1 bob | 111 | Sep 4 14:59 new.gif |
| -rw-r--r-- | 1 bob | 660 | Apr 4 2002 nolinks.gif |
| -rw-r--r-- | 1 bob | 5580 | Feb 7 2002 nouserimage100x100.gif |
| -rw-r--r-- | 1 bob | 522 | Apr 4 2002 other.gif |
| -rw-r--r-- | 1 bob | 240 | Dec 11 2001 quality_0.gif |
| -rw-r--r-- | 1 bob | 243 | Dec 11 2001 quality_1.gif |
| -rw-r--r-- | 1 bob | 246 | Dec 11 2001 quality_2.gif |
| -rw-r--r-- | 1 bob | 242 | Dec 11 2001 quality_3.gif |
| -rw-r--r-- | 1 bob | 240 | Dec 11 2001 quality_4.gif |
| -rw-r--r-- | 1 bob | 172 | Dec 11 2001 quality_5.gif |
| -rw-r--r-- | 1 bob | 96 | Dec 11 2001 quality_unrated.gif |
| -rw-r--r-- | 1 bob | 295 | Nov 21 2001 rate_album4_0.gif |
| -rw-r--r-- | 1 bob | 301 | Nov 21 2001 rate_album4_1.gif |
| -rw-r--r-- | 1 bob | 229 | Nov 21 2001 rate_album4_10.gif |
| -rw-r--r-- | 1 bob | 302 | Nov 21 2001 rate_album4_2.gif |
| -rw-r--r-- | 1 bob | 305 | Nov 21 2001 rate_album4_3.gif |
| -rw-r--r-- | 1 bob | 303 | Nov 21 2001 rate_album4_4.gif |
| -rw-r--r-- | 1 bob | 304 | Nov 21 2001 rate_album4_5.gif |
| -rw-r--r-- | 1 bob | 297 | Nov 21 2001 rate_album4_6.gif |
| -rw-r--r-- | 1 bob | 301 | Nov 21 2001 rate_album4_7.gif |
| -rw-r--r-- | 1 bob | 296 | Nov 21 2001 rate_album4_8.gif |
| -rw-r--r-- | 1 bob | 293 | Nov 21 2001 rate_album4_9.gif |
| -rw-r--r-- | 1 bob | 308 | Nov 21 2001 rate_deed4_0.gif |
| -rw-r--r-- | 1 bob | 304 | Nov 21 2001 rate_deed4_1.gif |
| -rw-r--r-- | 1 bob | 229 | Nov 21 2001 rate_deed4_10.gif |
| -rw-r--r-- | 1 bob | 303 | Nov 21 2001 rate_deed4_2.gif |
| -rw-r--r-- | 1 bob | 307 | Nov 21 2001 rate_deed4_3.gif |
| -rw-r--r-- | 1 bob | 304 | Nov 21 2001 rate_deed4_4.gif |
| -rw-r--r-- | 1 bob | 305 | Nov 21 2001 rate_deed4_5.gif |
| -rw-r--r-- | 1 bob | 298 | Nov 21 2001 rate_deed4_6.gif |
| -rw-r--r-- | 1 bob | 302 | Nov 21 2001 rate_deed4_7.gif |
| -rw-r--r-- | 1 bob | 299 | Nov 21 2001 rate_deed4_8.gif |
| -rw-r--r-- | 1 bob | 297 | Nov 21 2001 rate_deed4_9.gif |
| -rw-r--r-- | 1 bob | 295 | Nov 21 2001 rate_song4_0.gif |
| -rw-r--r-- | 1 bob | 300 | Nov 21 2001 rate_song4_1.gif |
| -rw-r--r-- | 1 bob | 226 | Nov 21 2001 rate_song4_10.gif |
| -rw-r--r-- | 1 bob | 299 | Nov 21 2001 rate_song4_2.gif |
| -rw-r--r-- | 1 bob | 304 | Nov 21 2001 rate_song4_3.gif |
| -rw-r--r-- | 1 bob | 299 | Nov 21 2001 rate_song4_4.gif |
| -rw-r--r-- | 1 bob | 299 | Nov 21 2001 rate_song4_5.gif |
| -rw-r--r-- | 1 bob | 294 | Nov 21 2001 rate_song4_6.gif |
| -rw-r--r-- | 1 bob | 298 | Nov 21 2001 rate_song4_7.gif |
| -rw-r--r-- | 1 bob | 293 | Nov 21 2001 rate_song4_8.gif |
| -rw-r--r-- | 1 bob | 292 | Nov 21 2001 rate_song4_9.gif |
| -rw-r--r-- | 1 bob | 527 | Apr 17 2002 rateit.gif |
| -rw-r--r-- | 1 bob | 476 | Apr 3 2002 real.gif |
| -rw-r--r-- | 1 bob | 1061 | Jul 2 21:48 recommendations.gif |
| -rw-r--r-- | 1 bob | 1142 | Aug 8 23:12 recommendnewmusic.gif |
| -rw-r--r-- | 1 bob | 49 | Sep 5 2001 spacer.gif |
| -rw-r--r-- | 1 bob | 60 | Sep 13 2001 spacerline.gif |
| -rw-r--r-- | 1 bob | 268 | Dec 11 2001 stars--1.gif |
| -rw-r--r-- | 1 bob | 240 | Nov 16 2001 stars-0.gif |
| -rw-r--r-- | 1 bob | 243 | Feb 4 2002 stars-1.gif |
| -rw-r--r-- | 1 bob | 246 | Feb 4 2002 stars-2.gif |
| -rw-r--r-- | 1 bob | 242 | Feb 4 2002 stars-3.gif |
| -rw-r--r-- | 1 bob | 248 | Feb 4 2002 stars-4.gif |
| -rw-r--r-- | 1 bob | 234 | Feb 4 2002 stars-5.gif |
| -rw-r--r-- | 1 bob | 268 | Nov 16 2001 stars-new.gif |
| -rw-r--r-- | 1 bob | 818 | Jul 31 2001 uparrow.gif |
| -rw-r--r-- | 1 bob | 176 | Jul 31 2001 uptrend.gif |
| -rw-r--r-- | 1 bob | 2373 | Nov 21 2001 x-click-but6.gif |
| -rw-r--r-- | 1 bob | 429 | May 31 16:48 xml.gif |

./transpose/songsifter/java:
total 0

| | | | |
|---|---|---|---|
| drwxr-xr-x | 3 bob | 0 | Oct 18 15:01 com |

./transpose/songsifter/java/com:
total 4

| | | | |
|---|---|---|---|
| drwxr-xr-x | 9 bob | 4096 | Oct 18 15:05 transpose |

./transpose/songsifter/java/com/transpose:
total 95

| | | | |
|---|---|---|---|
| -rw-r--r-- | 1 bob | 780 | Sep 6 12:39 Makefile |
| -rw-r--r-- | 1 bob | 1774 | Feb 15 2002 Makefile.include |
| drwxr-xr-x | 4 bob | 16384 | Oct 18 15:01 deed |
| drwxr-xr-x | 2 bob | 4096 | Oct 18 15:01 k2math |
| drwxr-xr-x | 2 bob | 4096 | Oct 18 15:01 libs |
| drwxr-xr-x | 2 bob | 4096 | Oct 18 15:01 scheduledjobs |
| drwxr-xr-x | 5 bob | 36864 | Oct 18 15:01 songdeed |
| drwxr-xr-x | 3 bob | 12288 | Oct 18 15:01 tags |
| drwxr-xr-x | 3 bob | 16384 | Oct 18 15:01 util |

./transpose/songsifter/java/com/transpose/deed
total 314

| | | | |
|---|---|---|---|
| -rw-r--r-- | 1 bob | 6160 | May 1 13:02 AuctionItem.java |
| -rw-r--r-- | 1 bob | 28528 | Aug 8 20:27 BackgroundInfo.java |
| -rw-r--r-- | 1 bob | 6689 | Jul 1 16:23 BestDeedList.java |
| -rw-r--r-- | 1 bob | 4896 | Mar 14 2002 Bid.java |
| -rw-r--r-- | 1 bob | 976 | May 29 13:20 |
| | | | ChangedBestDeedList.java |
| -rw-r--r-- | 1 bob | 575 | Apr 26 11:06 ChangedDeedList.java |
| -rw-r--r-- | 1 bob | 5094 | Sep 4 14:59 ClickThru.java |
| -rw-r--r-- | 1 bob | 9078 | Sep 12 11:18 DBTableNames.java |
| -rw-r--r-- | 1 bob | 367 | Sep 12 11:18 DBTableSelector.java |
| -rw-r--r-- | 1 bob | 41674 | Aug 27 14:57 Deed.java |
| -rw-r--r-- | 1 bob | 12631 | Jul 1 16:23 DeedAndChildList.java |
| -rw-r--r-- | 1 bob | 8487 | Apr 10 2002 DeedComment.java |
| -rw-r--r-- | 1 bob | 922 | Mar 18 2002 DeedIDAndLevel.java |
| -rw-r--r-- | 1 bob | 973 | Apr 21 15:01 DeedList.java |
| -rw-r--r-- | 1 bob | 10870 | Jul 1 16:23 DeedListImplementor.java |
| -rw-r--r-- | 1 bob | 19138 | Aug 8 20:27 DeedRating.java |
| -rw-r--r-- | 1 bob | 3576 | Aug 2 22:58 DeedRatingTable.java |
| -rw-r--r-- | 1 bob | 2501 | Jul 25 13:52 DeedTable.java |
| -rw-r--r-- | 1 bob | 7493 | May 28 22:43 Deed_Fan.java |
| -rw-r--r-- | 1 bob | 13333 | Aug 28 17:10 DiscussionComment.java |
| -rw-r--r-- | 1 bob | 1419 | Apr 16 2002 FanDeedList.java |
| -rw-r--r-- | 1 bob | 3866 | Jul 22 17:23 K2Factory.java |
| -rw-r--r-- | 1 bob | 4762 | Aug 8 20:35 K2User.java |
| -rw-r--r-- | 1 bob | 3236 | Jun 21 20:11 K2UserList.java |
| -rw-r--r-- | 1 bob | 3937 | May 6 14:53 K2UserOption.java |
| -rw-r--r-- | 1 bob | 4497 | Jul 22 17:25 K2UserPoints.java |
| -rw-r--r-- | 1 bob | 26110 | Aug 9 14:00 K2UserValue.java |
| -rw-r--r-- | 1 bob | 4248 | Jul 22 17:27 K2UserValueTable.java |
| -rw-r--r-- | 1 bob | 3880 | Aug 28 17:10 MailingList.java |
| -rw-r--r-- | 1 bob | 249 | Jan 4 2002 Makefile |
| -rw-r--r-- | 1 bob | 3172 | Apr 16 2002 |
| | | | NeedRatingDeedListImplementor.java |
| -rw-r--r-- | 1 bob | 264 | Feb 5 2002 |
| | | | NotEnoughPointsException.java |
| -rw-r--r-- | 1 bob | 3548 | Sep 4 14:59 NotifyEvent.java |
| -rw-r--r-- | 1 bob | 10938 | Jul 22 17:28 PointsChange.java |
| -rw-r--r-- | 1 bob | 5100 | Jul 25 13:52 PointsChangeTable.java |
| -rw-r--r-- | 1 bob | 249 | Apr 21 14:54 Searchable.java |
| -rw-r--r-- | 1 bob | 2500 | Apr 25 09:05 |
| | | | SearchableDeedListImplementor.java |
| -rw-r--r-- | 1 bob | 17320 | Jul 25 13:52 Topic.java |
| -rw-r--r-- | 1 bob | 8916 | Sep 4 14:59 TopicComment.java |
| -rw-r--r-- | 1 bob | 2714 | Jul 25 13:52 TopicTable.java |
| drwxr-xr-x | 2 bob | 4096 | Oct 18 15:01 serviets |
| drwxr-xr-x | 2 bob | 4096 | Oct 18 15:01 test |

./transpose/songsifter/java/com/transpose/deed/servlets:
total 20

| | | | |
|---|---|---|---|
| -rw-r--r-- | 1 bob | 4900 | Jan 14 2002 DeedServlet.java |
| -rw-r--r-- | 1 bob | 3046 | May 6 14:55 EditDeedServlet.java |
| -rw-r--r-- | 1 bob | 250 | Jan 4 2002 Makefile |
| -rw-r--r-- | 1 bob | 4993 | Feb 3 2002 |
| | | | ModeratorCommentServlet.java |
| -rw-r--r-- | 1 bob | 1151 | Dec 26 2001 |
| | | | ServletParameterException.java |
| -rw-r--r-- | 1 bob | 3938 | Jun 21 20:11 StoreDeedServlet.java |

./transpose/songsifter/java/com/transpose/deed/test:
total 14

| | | | |
|---|---|---|---|
| -rw-r--r-- | 1 bob | 580 | Mar 12 2002 testclickthru.jsp |
| -rw-r--r-- | 1 bob | 817 | Sep 27 2001 testcounts.jsp |
| -rw-r--r-- | 1 bob | 1128 | Sep 19 2001 testdeednumbers.jsp |
| -rw-r--r-- | 1 bob | 1465 | Dec 11 2001 testdeedsforfan.jsp |
| -rw-r--r-- | 1 bob | 1376 | Sep 10 2001 testhistory.jsp |
| -rw-r--r-- | 1 bob | 930 | Mar 22 2002 testlatest.jsp |
| -rw-r--r-- | 1 bob | 1996 | Mar 21 2002 testneediest.jsp |
| -rw-r--r-- | 1 bob | 611 | Apr 17 2002 testoriginaldeed.jsp |
| -rw-r--r-- | 1 bob | 1057 | Mar 29 2002 testresetbest.jsp |

./transpose/songsifter/java/com/transpose/k2math:
total 152

| | | | |
|---|---|---|---|
| -rw-r--r-- | 1 bob | 293 | Jul 25 11:24 |
| | | | InconsistentDataException.java |
| -rw-r--r-- | 1 bob | 28766 | Aug 9 14:00 K2MathClass.java |
| -rw-r--r-- | 1 bob | 243 | Jan 29 2002 Makefile |
| -rw-r--r-- | 1 bob | 345 | Jan 29 2002 |
| | | | NotEnoughDataException.java |
| -rw-r--r-- | 1 bob | 203 | Mar 14 2002 PleaseStopException.java |
| -rw-r--r-- | 1 bob | 22809 | Aug 9 00:22 |
| | | | ProcessBackgroundRatingCutoffs.java |
| -rw-r--r-- | 1 bob | 78279 | Aug 9 00:22 |
| | | | ProcessDirtyDeedRatings.java |
| -rw-r--r-- | 1 bob | 19116 | Aug 8 20:27 ReinitializeMath.java |

./transpose/songsifter/java/com/transpose/libs:
total 10795

| | | | |
|---|---|---|---|
| -rw-r--r-- | 1 bob | 45386 | Aug 30 2001 activation-1.0.1.jar |
| -rw-r--r-- | 1 bob | 379658 | Aug 30 2001 ecs-1.4.1.jar |
| -rw-r--r-- | 1 bob | 8381795 | Jul 31 2001 j2ee.jar |
| -rw-r--r-- | 1 bob | 89492 | Feb 7 2002 jblogger-0.3.jar |
| -rw-r--r-- | 1 bob | 75743 | Jul 31 2001 jsdk.jar |
| -rw-r--r-- | 1 bob | 280984 | Aug 30 2001 mail-1.2.jar |
| -rw-r--r-- | 1 bob | 9549 | Nov 13 2001 mailet.jar |
| -rw-r--r-- | 1 bob | 259168 | Jul 31 2001 sdsuLibJKD12.jar |
| -rw-r--r-- | 1 bob | 686802 | Aug 30 2001 turbine-2.1.jar |
| -rw-r--r-- | 1 bob | 840704 | Aug 30 2001 xerces-1.3.0.jar |

./transpose/songsifter/java/com/transpose/scheduledjobs:
total 20

| | | | |
|---|---|---|---|
| -rw-r--r-- | 1 bob | 2367 | Jun 18 17:41 JobMinder.java |
| -rw-r--r-- | 1 bob | 939 | Jun 18 17:41 |
| | | | JobMinderScheduledTask.java |
| -rw-r--r-- | 1 bob | 247 | Feb 27 2002 Makefile |
| -rw-r--r-- | 1 bob | 326 | Mar 1 2002 PoliteRunnable.java |
| -rw-r--r-- | 1 bob | 9403 | Apr 2 2002 ScheduledTask.java |
| -rw-r--r-- | 1 bob | 1746 | Mar 15 2002 ScheduledTaskList.java |
| -rw-r--r-- | 1 bob | 1774 | Mar 29 2002 TestScheduledTask.java |

./transpose/songsifter/java/com/transpose/songdeed:
total 303

| | | | |
|---|---|---|---|
| -rw-r--r-- | 1 bob | 12854 | Aug 28 17:10 AlbumAuctionItem.java |
| -rw-r--r-- | 1 bob | 7649 | Jun 27 10:22 |
| | | | AlbumAuctionItemList.java |
| -rw-r--r-- | 1 bob | 1026 | Aug 28 17:10 AlbumBid.java |
| -rw-r--r-- | 1 bob | 4161 | Aug 28 17:10 Announcement.java |
| -rw-r--r-- | 1 bob | 3736 | May 6 15:38 ArtistList.java |
| -rw-r--r-- | 1 bob | 4860 | Apr 12 2002 BlogSongs.java |
| -rw-r--r-- | 1 bob | 927 | Apr 12 2002 |
| | | | BlogSongsScheduledTask.java |
| -rw-r--r-- | 1 bob | 4827 | Sep 4 14:59 EMScheduledTasks.java |
| -rw-r--r-- | 1 bob | 5357 | Jun 18 16:44 EmailAFriend.java |
| -rw-r--r-- | 1 bob | 2519 | Aug 28 17:10 EmailAFriendTopic.java |
| -rw-r--r-- | 1 bob | 23149 | Sep 4 14:59 Fan.java |
| -rw-r--r-- | 1 bob | 6664 | Jul 16 16:50 FanList.java |
| -rw-r--r-- | 1 bob | 4076 | Sep 4 14:59 FanOption.java |
| -rw-r--r-- | 1 bob | 11085 | Jul 25 15:04 |
| | | | FanSongPointsChangesList.java |
| -rw-r--r-- | 1 bob | 4705 | Aug 28 17:10 Fan_Genre.java |
| -rw-r--r-- | 1 bob | 3905 | May 28 22:43 Fan_GenreList.java |
| -rw-r--r-- | 1 bob | 996 | Aug 28 17:10 GeneralComment.java |
| -rw-r--r-- | 1 bob | 4107 | Aug 28 17:10 Genre.java |
| -rw-r--r-- | 1 bob | 6712 | Jul 22 17:23 K2SongFactory.java |
| -rw-r--r-- | 1 bob | 458 | Feb 26 2002 LinkEntry.java |
| -rw-r--r-- | 1 bob | 4682 | Aug 28 17:10 Login.java |
| -rw-r--r-- | 1 bob | 4397 | Jul 16 16:52 LoginList.java |
| -rw-r--r-- | 1 bob | 251 | Jan 4 2002 Makefile |
| -rw-r--r-- | 1 bob | 1078 | Jul 1 16:24 NeedRatingDeedList.java |
| -rw-r--r-- | 1 bob | 6044 | Aug 28 17:10 News.java |
| -rw-r--r-- | 1 bob | 3349 | Apr 16 2002 NewsList.java |
| -rw-r--r-- | 1 bob | 5095 | Sep 4 14:59 ProcessArtistWeeklyPro- |
| | | | motionEmail.java |
| -rw-r--r-- | 1 bob | 1203 | Sep 4 14:59 ProcessArtistWeeklyPro- |
| | | | motionEmailScheduledTask.java |
| -rw-r--r-- | 1 bob | 1518 | Mar 30 2002 |
| | | | ProcessAuctionResults.java |
| -rw-r--r-- | 1 bob | 1049 | Mar 14 2002 ProcessAuctionRe- |
| | | | sultsScheduledTask.java |
| -rw-r--r-- | 1 bob | 577 | May 6 14:59 ProcessBack- |
| | | | groundSongRatingCutoffs.java |
| -rw-r--r-- | 1 bob | 4400 | Apr 22 10:46 ProcessBids.java |
| -rw-r--r-- | 1 bob | 1254 | Mar 15 2002 ProcessBidsDollars.java |
| -rw-r--r-- | 1 bob | 1025 | Mar 15 2002 ProcessBidsDollarsSched- |
| | | | uledTask.java |
| -rw-r--r-- | 1 bob | 1245 | Mar 18 2002 ProcessBidsPoints.java |
| -rw-r--r-- | 1 bob | 993 | Mar 15 2002 |
| | | | ProcessBidsPointsScheduledTask.java |
| -rw-r--r-- | 1 bob | 708 | May 6 14:59 |
| | | | ProcessDirtySongDeedRatings.java |
| -rw-r--r-- | 1 bob | 1107 | Mar 15 2002 |
| | | | ProcessDirtySongDeedRatingsSched- |
| | | | uledTask.java |
| -rw-r--r-- | 1 bob | 1098 | Mar 15 2002 |
| | | | ProcessSongBGInfoScheduledTask.java |
| -rw-r--r-- | 1 bob | 5514 | Jul 25 13:52 PromotedTopic.java |
| -rw-r--r-- | 1 bob | 764 | Aug 28 17:10 |
| | | | PromotedTopicDollars.java |
| -rw-r--r-- | 1 bob | 4121 | Apr 16 2002 PromotedTopicList.java |
| -rw-r--r-- | 1 bob | 678 | Feb 3 2002 |
| | | | PromotedTopicListDollars.java |
| -rw-r--r-- | 1 bob | 672 | Feb 3 2002 |
| | | | PromotedTopicListPoints.java |
| -rw-r--r-- | 1 bob | 759 | Aug 28 17:10 |
| | | | PromotedTopicPoints.java |
| -rw-r--r-- | 1 bob | 526 | May 6 14:59 ReinitializeSongMath.java |
| -rw-r--r-- | 1 bob | 903 | Aug 28 17:10 SongBackgroundInfo.java |
| -rw-r--r-- | 1 bob | 1309 | Jul 1 16:24 SongBestDeedList.java |
| -rw-r--r-- | 1 bob | 1327 | Jul 1 16:24 |
| | | | SongChangedBestDeedList.java |
| -rw-r--r-- | 1 bob | 1316 | Jul 1 16:24 SongChangedDeedList.java |
| -rw-r--r-- | 1 bob | 24137 | Aug 27 15:53 SongDeed.java |
| -rw-r--r-- | 1 bob | 1005 | Aug 28 17:10 SongDeedComment.java |
| -rw-r--r-- | 1 bob | 514 | Apr 21 15:01 SongDeedList.java |
| -rw-r--r-- | 1 bob | 2649 | Jul 1 16:24 |
| | | | SongDeedListImplementor.java |
| -rw-r--r-- | 1 bob | 602 | Apr 21 15:01 |
| | | | SongDeedListSearcher.java |
| -rw-r--r-- | 1 bob | 1433 | Aug 28 17:10 SongDeedRating.java |
| -rw-r--r-- | 1 bob | 3573 | Jul 11 19:06 SongDeedValidator.java |
| -rw-r--r-- | 1 bob | 3413 | Aug 28 17:10 SongDeed_Fan.java |
| -rw-r--r-- | 1 bob | 821 | Jul 1 16:24 SongFanDeedList.java |
| -rw-r--r-- | 1 bob | 933 | Aug 28 17:10 SongFanValue.java |
| -rw-r--r-- | 1 bob | 8473 | Aug 28 17:10 SongLink.java |
| -rw-r--r-- | 1 bob | 688 | Aug 28 17:10 SongPointsChange.java |
| -rw-r--r-- | 1 bob | 4190 | Jul 1 16:24 |
| | | | SongSearchBestDeedList.java |
| -rw-r--r-- | 1 bob | 11881 | Sep 4 14:59 SongTopic.java |
| -rw-r--r-- | 1 bob | 7714 | Mar 18 2002 SongTopicBid.java |
| -rw-r--r-- | 1 bob | 776 | Aug 28 17:10 |
| | | | SongTopicBidDollars.java |
| -rw-r--r-- | 1 bob | 915 | Feb 3 2002 |
| | | | SongTopicBidDollarsList.java |
| -rw-r--r-- | 1 bob | 4802 | Apr 16 2002 SongTopicBidList.java |
| -rw-r--r-- | 1 bob | 774 | Aug 28 17:10 SongTopicBidPoints.java |
| -rw-r--r-- | 1 bob | 925 | Feb 3 2002 |
| | | | SongTopicBidPointsList.java |
| -rw-r--r-- | 1 bob | 1015 | Aug 28 17:10 SongTopicComment.java |
| -rw-r--r-- | 1 bob | 4888 | Aug 28 17:10 Vendor.java |
| drwxr-xr-x | 2 bob | 0 | Oct 18 15:01 jobs |
| drwxr-xr-x | 2 bob | 8192 | Oct 18 15:01 servlets |
| drwxr-xr-x | 2 bob | 8192 | Oct 18 15:01 test |

./transpose/songsifter/java/com/transpose/songdeed/jobs:
total 2

| | | | |
|---|---|---|---|
| -rw-r--r-- | 1 bob | 639 | May 6 14:59 processbids.jsp |
| -rw-r--r-- | 1 bob | 497 | May 6 14:59 processsongratings.jsp |

./transpose/songsifter/java/com/transpose/songdeed/servlets:
total 98

| | | | |
|---|---|---|---|
| -rw-r--r-- | 1 bob | 7637 | Jul 16 16:50 AlbumBidServlet.java |
| -rw-r--r-- | 1 bob | 841 | Sep 13 18:20 AppInit.java |
| -rw-r--r-- | 1 bob | 4995 | Jul 16 16:50 AuctionServlet.java |
| -rw-r--r-- | 1 bob | 5774 | Apr 16 2002 DeedRatingServlet.java |
| -rw-r--r-- | 1 bob | 5598 | Jun 21 20:11 EditSongDeedServlet.java |
| -rw-r--r-- | 1 bob | 27736 | Sep 13 18:20 FanServlet.java |
| -rw-r--r-- | 1 bob | 3695 | Jun 27 10:22 |
| | | | GeneralCommentServlet.java |
| -rw-r--r-- | 1 bob | 7034 | Aug 8 20:35 LoginServlet.java |
| -rw-r--r-- | 1 bob | 254 | Jan 4 2002 Makefile |
| -rw-r--r-- | 1 bob | 2334 | Apr 16 2002 NewsServlet.java |
| -rw-r--r-- | 1 bob | 4373 | Feb 3 2002 PayPalServlet.java |
| -rw-r--r-- | 1 bob | 3067 | Mar 12 2002 |
| | | | SongDeedCommentServlet.java |
| -rw-r--r-- | 1 bob | 925 | Jan 18 2002 |
| | | | SongModeratorCommentServlet.java |
| -rw-r--r-- | 1 bob | 629 | Feb 3 2002 |
| | | | SongTopicBidDollarsServlet.java |
| -rw-r--r-- | 1 bob | 626 | Feb 3 2002 |
| | | | SongTopicBidPointsServlet.java |
| -rw-r--r-- | 1 bob | 5988 | Mar 19 2002 SongTopicBidServlet.java |
| -rw-r--r-- | 1 bob | 3100 | Feb 4 2002 |
| | | | SongTopicCommentServlet.java |
| -rw-r--r-- | 1 bob | 778 | Feb 19 2002 |
| | | | SpendMyPointsServlet.java |
| -rw-r--r-- | 1 bob | 1590 | Jun 21 20:11 |
| | | | StoreSongDeedServlet.java |
| -rw-r--r-- | 1 bob | 4572 | May 6 14:59 StressTestServlet.java |

./transpose/songsifter/java/com/transpose/songdeed/test:
total 50

| | | | |
|---|---|---|---|
| -rw-r--r-- | 1 bob | 866 | Sep 7 2001 addToFanGenreList.jsp |
| -rw-r--r-- | 1 bob | 1102 | Apr 10 2002 reloadblog.jsp |
| -rw-r--r-- | 1 bob | 832 | Oct 12 2001 testannouncement.jsp |
| -rw-r--r-- | 1 bob | 634 | Jul 1 16:24 testartistwebsite.jsp |
| -rw-r--r-- | 1 bob | 469 | Apr 12 2002 testblog.jsp |
| -rw-r--r-- | 1 bob | 847 | Jul 1 16:24 testdeedfanlist.jsp |
| -rw-r--r-- | 1 bob | 2043 | Dec 27 2001 testerror.jsp |
| -rw-r--r-- | 1 bob | 2134 | Dec 5 2001 testfanoption.jsp |
| -rw-r--r-- | 1 bob | 979 | Feb 3 2002 testfanpoints.jsp |
| -rw-r--r-- | 1 bob | 562 | Jan 29 2002 testgenres.jsp |
| -rw-r--r-- | 1 bob | 829 | Jul 1 16:24 testgetlink.jsp |
| -rw-r--r-- | 1 bob | 3703 | Feb 7 2002 testpoints.jsp |
| -rw-r--r-- | 1 bob | 792 | Feb 3 2002 testpromotedtopiclist.jsp |
| -rw-r--r-- | 1 bob | 1636 | Dec 11 2001 testsearch.jsp |
| -rw-r--r-- | 1 bob | 696 | Jul 1 16:24 testshowsongdeed.jsp |
| -rw-r--r-- | 1 bob | 3179 | Jul 1 16:24 testsongdeed.jsp |
| -rw-r--r-- | 1 bob | 724 | Oct 3 2001 testsongdeed_fan.jsp |
| -rw-r--r-- | 1 bob | 911 | Jul 1 16:24 |
| | | | testsongdeedhistoryvector.jsp |
| -rw-r--r-- | 1 bob | 1534 | Dec 14 2001 testsongdeedlist.jsp |
| -rw-r--r-- | 1 bob | 4594 | Jul 30 18:42 testsongdeedrating.jsp |
| -rw-r--r-- | 1 bob | 681 | Jan 29 2002 testsongdeedvalue.jsp |
| -rw-r--r-- | 1 bob | 755 | Jan 29 2002 testsongfanvalue.jsp |
| -rw-r--r-- | 1 bob | 997 | Feb 3 2002 testsongtopicbid.jsp |
| -rw-r--r-- | 1 bob | 1105 | Feb 3 2002 testsongtopicbidlist.jsp |
| -rw-r--r-- | 1 bob | 1131 | Feb 3 2002 |
| | | | testsongtopicbidpointslist.jsp |
| -rw-r--r-- | 1 bob | 1827 | Jan 30 2002 testsongtopiccomment.jsp |
| -rw-r--r-- | 1 bob | 902 | Jan 31 2002 |
| | | | testsongtopiccommentdate.jsp |
| -rw-r--r-- | 1 bob | 1366 | Jan 30 2002 |
| | | | testsongtopiccommentlist.jsp |
| -rw-r--r-- | 1 bob | 1063 | Oct 18 2001 testsongtopicexists.jsp |

./transpose/songsifter/java/com/transpose/tags:
total 73

| | | | |
|---|---|---|---|
| -rw-r--r-- | 1 bob | 803 | Nov 23 2001 DisplayAIM.java |
| -rw-r--r-- | 1 bob | 7129 | Sep 4 14:59 DisplayDeedHistory.java |
| -rw-r--r-- | 1 bob | 1763 | Nov 1 2001 |
| | | | DisplayGenreCheckboxList.java |
| -rw-r--r-- | 1 bob | 1349 | Nov 1 2001 DisplayGenreCheck- |
| | | | boxListLoggedIn.java |
| -rw-r--r-- | 1 bob | 994 | Nov 23 2001 |
| | | | DisplayGenreDropDown.java |
| -rw-r--r-- | 1 bob | 806 | Nov 23 2001 DisplayICQ.java |
| -rw-r--r-- | 1 bob | 1633 | Nov 1 2001 |
| | | | DisplayLatestDetailedNews.java |
| -rw-r--r-- | 1 bob | 1179 | Nov 28 2001 DisplayLatestNews.java |
| -rw-r--r-- | 1 bob | 3351 | May 10 11:41 |
| | | | DisplayListNavigation.java |
| -rw-r--r-- | 1 bob | 3731 | Aug 8 20:35 |
| | | | DisplayPlainMusicLinks.java |
| -rw-r--r-- | 1 bob | 1217 | Nov 23 2001 |
| | | | DisplayPresetGenreDropDown.java |
| -rw-r--r-- | 1 bob | 375 | Apr 16 2002 |
| | | | DisplaySongBestDeedList.java |
| -rw-r--r-- | 1 bob | 421 | May 29 13:21 |
| | | | DisplaySongChangedBestDeedList.java |
| -rw-r--r-- | 1 bob | 413 | Apr 26 11:18 |
| | | | DisplaySongChangedDeedList.java |
| -rw-r--r-- | 1 bob | 16634 | Sep 4 14:59 DisplaySongDeedList.java |
| -rw-r--r-- | 1 bob | 893 | Apr 16 2002 |
| | | | DisplaySongFanDeedList.java |
| -rw-r--r-- | 1 bob | 3371 | Jul 1 16:25 DisplaySongLinks.java |
| -rw-r--r-- | 1 bob | 907 | Apr 16 2002 |
| | | | DisplaySongNeedyDeedList.java |
| -rw-r--r-- | 1 bob | 1385 | Apr 21 14:56 |
| | | | DisplaySongSearchBestDeedList.java |
| -rw-r--r-- | 1 bob | 2945 | May 7 08:38 DisplayTopScorers.java |
| -rw-r--r-- | 1 bob | 2857 | May 16 16:51 |
| | | | DisplayTopScorersToday.java |
| -rw-r--r-- | 1 bob | 1366 | Nov 1 2001 DisplayTopScouts.java |
| -rw-r--r-- | 1 bob | 1370 | Nov 1 2001 DisplayTopWriters.java |
| -rw-r--r-- | 1 bob | 979 | Mar 13 2002 FairtunesSearchURL.java |
| -rw-r--r-- | 1 bob | 239 | Jan 4 2002 Makefile |
| -rw-r--r-- | 1 bob | 921 | Feb 8 2002 Picture.java |
| -rw-r--r-- | 1 bob | 1319 | Nov 23 2001 VendorList.java |
| -rw-r--r-- | 1 bob | 1601 | Mar 13 2002 VendorSearchURL.java |
| drwxr-xr-x | 2 bob | 0 | Oct 18 15:01 test |

./transpose/songsifter/java/com/transpose/tags/test:
total 1

| | | | |
|---|---|---|---|
| -rw-r--r-- | 1 bob | 473 | Feb 3 2002 testtopscorers.jsp |

./transpose/songsifter/java/com/transpose/util:
total 145

| | | | |
|---|---|---|---|
| -rw-r--r-- | 1 bob | 1531 | Jul 14 14:20 Assert.java |
| -rw-r--r-- | 1 bob | 5363 | Feb 11 2002 BreadCrumbs.java |
| -rw-r--r-- | 1 bob | 1302 | Jul 11 20:18 CookieUtils.java |
| -rw-r--r-- | 1 bob | 246 | Dec 11 2001 DBConfig.java |
| -rw-r--r-- | 1 bob | 3000 | Mar 21 2002 DBConnectionHelper.java |
| -rw-r--r-- | 1 bob | 1636 | Apr 2 2002 DBQueryHelper.java |
| -rw-r--r-- | 1 bob | 2011 | Apr 2 2002 DBUpdateHelper.java |
| -rw-r--r-- | 1 bob | 1635 | Jan 29 2002 DateUtils.java |
| -rw-r--r-- | 1 bob | 7010 | Jul 31 2001 DocumentObject.java |
| -rw-r--r-- | 1 bob | 2134 | Feb 14 2002 Dumper.java |
| -rw-r--r-- | 1 bob | 1267 | Apr 16 2002 DynamicPagedList.java |
| -rw-r--r-- | 1 bob | 11297 | Nov 1 2001 ElementObject.java |
| -rw-r--r-- | 1 bob | 4450 | Mar 20 2002 ErrorNotifier.java |
| -rw-r--r-- | 1 bob | 2503 | Jul 1 16:26 ID.java |
| -rw-r--r-- | 1 bob | 321 | Jul 31 2001 |
| | | | KeyNotFoundException.java |
| -rw-r--r-- | 1 bob | 3625 | Feb 25 2002 KeyedStoreRecord.java |
| -rw-r--r-- | 1 bob | 555 | Jul 31 2001 LoggedException.java |
| -rw-r--r-- | 1 bob | 1026 | Nov 1 2001 Mailer.java |
| -rw-r--r-- | 1 bob | 247 | Jan 4 2002 Makefile |
| -rw-r--r-- | 1 bob | 1448 | Apr 16 2002 PagedList.java |
| -rw-r--r-- | 1 bob | 7797 | Jul 22 17:22 |
| | | | PreparedStatementHelper.java |
| -rw-r--r-- | 1 bob | 2519 | May 16 13:30 RSSDocument.java |
| -rw-r--r-- | 1 bob | 1017 | May 13 16:22 RSSEnclosure.java |
| -rw-r--r-- | 1 bob | 1844 | May 16 13:30 RSSItem.java |
| -rw-r--r-- | 1 bob | 2231 | Apr 25 16:37 RadioBlogger.java |
| -rw-r--r-- | 1 bob | 1069 | Aug 8 20:35 RandomString.java |
| -rw-r--r-- | 1 bob | 5422 | Jul 16 16:50 Rating.java |
| -rw-r--r-- | 1 bob | 5838 | Jul 11 20:18 ResultSetHelper.java |
| -rw-r--r-- | 1 bob | 897 | Jan 18 2002 SQLFormat.java |
| -rw-r--r-- | 1 bob | 458 | Mar 29 2002 Singleton.java |
| -rw-r--r-- | 1 bob | 3166 | Feb 26 2002 SingletonStoreRecord.java |
| -rw-r--r-- | 1 bob | 22004 | Jul 25 13:52 StoreRecord.java |
| -rw-r--r-- | 1 bob | 656 | Jan 29 2002 StringDumper.java |
| -rw-r--r-- | 1 bob | 5950 | May 16 13:30 StringFormat.java |
| -rw-r--r-- | 1 bob | 900 | Apr 25 16:37 TestURL.java |
| -rw-r--r-- | 1 bob | 3474 | Jul 5 14:15 TransactionConnection.java |
| -rw-r--r-- | 1 bob | 621 | Mar 1 2002 WaitThread.java |
| -rw-r--r-- | 1 bob | 657 | Jul 31 2001 XMLParsingException.java |
| -rw-r--r-- | 1 bob | 1671 | Nov 1 2001 XercesErrorHandler.java |
| -rw-r--r-- | 1 bob | 6617 | May 16 13:30 XmlWriter.java |
| drwxr-xr-x | 2 bob | 0 | Oct 18 15:01 servlets |

./transpose/songsifter/java/com/transpose/util/servlets
total 1

| | | | |
|---|---|---|---|
| -rw-r--r-- | 1 bob | 248 | Jan 4 2002 Makefile |

./transpose/songsifter/jsps:
total 677

| | | | |
|---|---|---|---|
| -rw-r--r-- | 1 bob | 4404 | Aug 8 20:27 about.jsp |
| -rw-r--r-- | 1 bob | 4976 | Sep 4 14:59 aboutartists.jsp |
| -rw-r--r-- | 1 bob | 2664 | Aug 8 20:27 aboutauctions.jsp |
| -rw-r--r-- | 1 bob | 7213 | Aug 8 20:27 aboutcriteria.jsp |
| -rw-r--r-- | 1 bob | 2953 | Sep 13 18:20 abouthosting.jsp |
| -rw-r--r-- | 1 bob | 5330 | Aug 8 20:27 aboutnewmusic.jsp |
| -rw-r--r-- | 1 bob | 3313 | Aug 8 20:27 aboutpoints.jsp |
| -rw-r--r-- | 1 bob | 3747 | Aug 8 20:27 aboutpredict.jsp |
| -rw-r--r-- | 1 bob | 2874 | Aug 8 20:27 aboutrecommend.jsp |
| -rw-r--r-- | 1 bob | 4670 | Aug 8 20:27 aboutreviews.jsp |
| -rw-r--r-- | 1 bob | 3798 | Aug 8 20:27 aboutsponsor.jsp |
| -rw-r--r-- | 1 bob | 4074 | Aug 8 20:27 aboutthecompetition.jsp |
| -rw-r--r-- | 1 bob | 930 | Aug 8 20:27 addtomailinglist.jsp |
| -rw-r--r-- | 1 bob | 1082 | Aug 8 20:27 admin.jsp |
| -rw-r--r-- | 1 bob | 2407 | Aug 8 20:27 allbuckssponsors.jsp |
| -rw-r--r-- | 1 bob | 1515 | Aug 8 20:27 allpointssponsors.jsp |
| -rw-r--r-- | 1 bob | 2407 | Aug 8 20:27 allsponsors.jsp |
| -rw-r--r-- | 1 bob | 4960 | Aug 8 20:27 artistalreadyloggedin.jsp |
| -rw-r--r-- | 1 bob | 2671 | Aug 12 15:34 artistlist.jsp |
| -rw-r--r-- | 1 bob | 4073 | Aug 8 20:27 audiohelp.jsp |
| -rw-r--r-- | 1 bob | 595 | Apr 30 16:12 autologin.jsp |
| -rw-r--r-- | 1 bob | 3893 | Apr 26 16:08 badge.jsp |
| -rw-r--r-- | 1 bob | 448 | Aug 8 20:27 badge_bestrecs.jsp |
| -rw-r--r-- | 1 bob | 3196 | Aug 28 14:56 badgedata_bestrecs.jsp |
| -rw-r--r-- | 1 bob | 4303 | Aug 8 20:27 badges.jsp |
| -rw-r--r-- | 1 bob | 895 | May 15 13:17 badgestyle.css |
| -rw-r--r-- | 1 bob | 440 | Dec 6 2001 beginbody.jsp |
| -rw-r--r-- | 1 bob | 8276 | Sep 6 12:42 best.jsp |
| -rw-r--r-- | 1 bob | 7363 | Aug 12 15:34 changed.jsp |
| -rw-r--r-- | 1 bob | 4184 | Aug 8 20:27 changedbest.jsp |
| -rw-r--r-- | 1 bob | 1717 | Aug 8 20:27 changegenres.jsp |
| -rw-r--r-- | 1 bob | 9458 | Aug 8 20:27 confirmalbumbid.jsp |
| -rw-r--r-- | 1 bob | 2046 | Aug 8 20:27 contact.jsp |
| -rw-r--r-- | 1 bob | 1704 | Aug 8 20:27 copyright.jsp |
| -rw-r--r-- | 1 bob | 8752 | Aug 8 20:27 create.jsp |
| -rw-r--r-- | 1 bob | 6597 | Sep 4 14:59 createaccount.jsp |
| -rw-r--r-- | 1 bob | 6632 | Sep 4 14:59 createartistaccount.jsp |
| -rw-r--r-- | 1 bob | 10273 | Aug 8 20:27 createartistrec.jsp |
| -rw-r--r-- | 1 bob | 4153 | Aug 8 20:27 createartistrecthanks.jsp |
| -rw-r--r-- | 1 bob | 2765 | Aug 8 20:27 createbid.jsp |
| -rw-r--r-- | 1 bob | 2294 | Aug 8 20:27 deedstats.jsp |
| -rw-r--r-- | 1 bob | 3086 | Aug 28 14:04 discussion.jsp |
| -rw-r--r-- | 1 bob | 8717 | Aug 8 20:27 edit.jsp |
| -rw-r--r-- | 1 bob | 8738 | Aug 8 20:27 editartistrec.jsp |
| -rw-r--r-- | 1 bob | 2400 | Sep 6 12:42 em_best_playlist.m3u |
| -rw-r--r-- | 1 bob | 2400 | Sep 6 12:42 em_latest_playlist.m3u |
| -rw-r--r-- | 1 bob | 3741 | Aug 8 20:27 emailafriend.jsp |
| -rw-r--r-- | 1 bob | 229 | Jan 29 2002 endbody.jsp |
| -rw-r--r-- | 1 bob | 2375 | Aug 8 20:27 error.jsp |
| -rw-r--r-- | 1 bob | 1309 | Oct 26 2001 fanheader.jsp |
| -rw-r--r-- | 1 bob | 3402 | Aug 12 15:34 fanlist.jsp |
| -rw-r--r-- | 1 bob | 25449 | Aug 8 20:27 faq.jsp |
| -rw-r--r-- | 1 bob | 2523 | May 7 17:06 footer.jsp |
| -rw-r--r-- | 1 bob | 2028 | Aug 8 20:27 friends.jsp |
| -rw-r--r-- | 1 bob | 5880 | Aug 8 20:27 gettingstarted.jsp |
| -rw-r--r-- | 1 bob | 9388 | Jun 14 13:56 header.jsp |
| -rw-r--r-- | 1 bob | 3311 | Aug 8 20:27 help.jsp |
| -rw-r--r-- | 1 bob | 501 | Sep 4 14:59 help_artistweeklyemail.jsp |
| -rw-r--r-- | 1 bob | 543 | Sep 4 14:59 help_asterisks.jsp |
| -rw-r--r-- | 1 bob | 416 | Feb 13 2002 help_beta.jsp |
| -rw-r--r-- | 1 bob | 416 | May 28 22:43 help_mailinglist.jsp |
| -rw-r--r-- | 1 bob | 647 | Apr 16 2002 help_musiclist.jsp |
| -rw-r--r-- | 1 bob | 491 | Feb 13 2002 help_mypoints.jsp |
| -rw-r--r-- | 1 bob | 621 | Mar 1 2002 help_myprivate.jsp |
| -rw-r--r-- | 1 bob | 537 | Mar 1 2002 help_mypublic.jsp |
| -rw-r--r-- | 1 bob | 486 | Mar 1 2002 help_mysite.jsp |
| -rw-r--r-- | 1 bob | 576 | Feb 13 2002 help_sponsoreddollars.jsp |
| -rw-r--r-- | 1 bob | 592 | Feb 13 2002 help_sponsoredpoints.jsp |
| -rw-r--r-- | 1 bob | 535 | Feb 13 2002 help_topscorers.jsp |
| -rw-r--r-- | 1 bob | 670 | Apr 16 2002 help_toratelist.jsp |
| -rw-r--r-- | 1 bob | 317 | Sep 4 14:59 helppopupend.jsp |
| -rw-r--r-- | 1 bob | 585 | Feb 13 2002 helppopupheader.jsp |
| -rw-r--r-- | 1 bob | 519 | Feb 13 2002 helppopupstart.jsp |
| drwxr-xr-x | 2 bob | 4096 | Oct 18 15:01 includes |
| -rw-r--r-- | 1 bob | 4622 | Aug 8 20:27 index.jsp |
| -rw-r--r-- | 1 bob | 3628 | Jul 16 16:50 jspheader.jsp |
| -rw-r--r-- | 1 bob | 1564 | Apr 16 2002 l.jsp |
| -rw-r--r-- | 1 bob | 3116 | Aug 8 20:27 lastloginlist.jsp |
| -rw-r--r-- | 1 bob | 2141 | Aug 8 20:27 lastmusiccomments.jsp |
| -rw-r--r-- | 1 bob | 2175 | Aug 8 20:35 lastratingnotes.jsp |
| -rw-r--r-- | 1 bob | 2186 | Aug 8 20:27 |
| | | | lastrecommendationcomments.jsp |
| -rw-r--r-- | 1 bob | 6545 | Aug 8 20:27 login.jsp |
| -rw-r--r-- | 1 bob | 304 | Jul 16 16:50 logout.jsp |
| -rw-r--r-- | 1 bob | 2400 | Sep 6 12:42 m3u.m3u |
| -rw-r--r-- | 1 bob | 3190 | Aug 8 20:27 mailpassword.jsp |
| -rw-r--r-- | 1 bob | 6065 | Aug 28 14:04 memberprofile.jsp |
| -rw-r--r-- | 1 bob | 7534 | Sep 13 18:20 music.jsp |
| -rw-r--r-- | 1 bob | 9332 | Aug 9 16:09 musiccomments.jsp |
| -rw-r--r-- | 1 bob | 9065 | Aug 28 14:04 musicdiscussion.jsp |
| -rw-r--r-- | 1 bob | 5787 | Sep 4 14:59 mypoints.jsp |
| -rw-r--r-- | 1 bob | 17942 | Sep 4 14:59 mysettings.jsp |
| -rw-r--r-- | 1 bob | 12121 | Aug 12 15:34 needrating.jsp |
| -rw-r--r-- | 1 bob | 2103 | Aug 8 20:27 newartistintro.jsp |
| -rw-r--r-- | 1 bob | 4002 | Aug 8 20:27 newmusiclinks.jsp |
| -rw-r--r-- | 1 bob | 4355 | Aug 8 20:27 newsletter-1-1.jsp |
| -rw-r--r-- | 1 bob | 6165 | Aug 8 20:27 newsletter-1-2.jsp |
| -rw-r--r-- | 1 bob | 116 | Apr 3 2002 openLetter.jsp |
| -rw-r--r-- | 1 bob | 552 | Aug 8 20:27 paypalfail.jsp |
| -rw-r--r-- | 1 bob | 546 | Aug 8 20:27 paypalsuccess.jsp |
| -rw-r--r-- | 1 bob | 23982 | Sep 4 14:59 |
| | | | positiverecommendation.jsp |
| -rw-r--r-- | 1 bob | 7270 | Aug 8 20:27 preview.jsp |
| -rw-r--r-- | 1 bob | 6849 | Aug 8 20:27 previewartistrec.jsp |
| -rw-r--r-- | 1 bob | 2031 | Aug 8 20:27 privacy.jsp |
| -rw-r--r-- | 1 bob | 3528 | Aug 8 20:27 quickstart.jsp |
| -rw-r--r-- | 1 bob | 9052 | Aug 28 14:04 ratingnotes.jsp |
| -rw-r--r-- | 1 bob | 8962 | Aug 8 20:27 |
| | | | recommendationcomments.jsp |
| -rw-r--r-- | 1 bob | 88 | Sep 4 14:59 robots.txt |
| -rw-r--r-- | 1 bob | 3058 | May 29 17:29 rssfeed.jsp |
| -rw-r--r-- | 1 bob | 2727 | Aug 8 20:27 rssfeedsexplained.jsp |
| -rw-r--r-- | 1 bob | 3598 | Aug 8 20:27 rulesforgoodreviews.jsp |
| -rw-r--r-- | 1 bob | 7514 | Aug 8 20:27 searchresults.jsp |
| -rw-r--r-- | 1 bob | 886 | Aug 8 20:27 showbadge.jsp |
| -rw-r--r-- | 1 bob | 2151 | Jun 21 20:10 sidebarauctions.jsp |
| -rw-r--r-- | 1 bob | 442 | Jun 21 20:10 sidebarbadge.jsp |
| -rw-r--r-- | 1 bob | 974 | May 20 08:46 sidebardiscuss.jsp |
| -rw-r--r-- | 1 bob | 2228 | Jul 11 20:18 sidebarmailinglist.jsp |
| -rw-r--r-- | 1 bob | 1945 | May 20 08:46 sidebarmypoints.jsp |
| -rw-r--r-- | 1 bob | 3424 | Jun 21 20:10 sidebarsponsoredmusic.jsp |
| -rw-r--r-- | 1 bob | 2458 | May 28 22:43 sidebartopdailyscorers.jsp |
| -rw-r--r-- | 1 bob | 926 | May 20 08:46 sidebartopscorers.jsp |
| -rw-r--r-- | 1 bob | 428 | Jul 16 16:52 siteoffline.jsp |
| -rw-r--r-- | 1 bob | 845 | Jul 16 16:50 songdeedlistheader.jsp |
| -rw-r--r-- | 1 bob | 9737 | Aug 8 20:27 spendmypoints.jsp |
| -rw-r--r-- | 1 bob | 4335 | Aug 8 20:27 sponsorasong.jsp |
| -rw-r--r-- | 1 bob | 3682 | Aug 28 14:04 sponsoredmusicbucks.jsp |
| -rw-r--r-- | 1 bob | 3764 | Aug 28 14:04 sponsoredmusicpoints.jsp |
| -rw-r--r-- | 1 bob | 4610 | Aug 8 20:27 sponsorwithbucks.jsp |
| -rw-r--r-- | 1 bob | 6706 | Aug 8 20:27 sponsorwithpoints.jsp |
| -rw-r--r-- | 1 bob | 2650 | Aug 8 20:27 startdiscussion.jsp |
| -rw-r--r-- | 1 bob | 7417 | Aug 8 20:27 stats.jsp |
| -rw-r--r-- | 1 bob | 789 | Dec 13 2001 stresstesting.jsp |
| -rw-r--r-- | 1 bob | 5667 | Apr 22 09:23 style.css |
| -rw-r--r-- | 1 bob | 3201 | Aug 8 20:27 template.jsp |
| -rw-r--r-- | 1 bob | 3280 | Jul 25 14:58 testvalidity.jsp |
| -rw-r--r-- | 1 bob | 3537 | Aug 8 20:27 topmonthlyscorerslist.jsp |
| -rw-r--r-- | 1 bob | 814 | Aug 8 20:27 topreviewwriters.jsp |
| -rw-r--r-- | 1 bob | 3140 | Aug 8 20:27 topscorerslist.jsp |
| -rw-r--r-- | 1 bob | 804 | Aug 8 20:27 topscouts.jsp |
| -rw-r--r-- | 1 bob | 4260 | Aug 8 20:27 tos.jsp |
| -rw-r--r-- | 1 bob | 5865 | Sep 4 14:59 updateemailsettings.jsp |
| -rw-r--r-- | 1 bob | 8251 | Aug 8 20:27 updatememberprofile.jsp |
| -rw-r--r-- | 1 bob | 5404 | Aug 8 20:27 updatepublicprofile.jsp |
| -rw-r--r-- | 1 bob | 5836 | Aug 8 20:27 updatesitesettings.jsp |
| -rw-r--r-- | 1 bob | 906 | Aug 8 20:27 values.jsp |
| -rw-r--r-- | 1 bob | 2259 | Aug 9 00:19 verify.jsp |
| -rw-r--r-- | 1 bob | 1408 | Aug 8 20:35 verify_failed.jsp |
| -rw-r--r-- | 1 bob | 738 | Aug 8 20:35 verify_mailed.jsp |
| -rw-r--r-- | 1 bob | 27188 | Sep 13 18:20 view.jsp |
| -rw-r--r-- | 1 bob | 7399 | Aug 8 20:27 viewalbumauctionitem.jsp |
| -rw-r--r-- | 1 bob | 3393 | Aug 8 20:27 viewdiscussion.jsp |
| -rw-r--r-- | 1 bob | 254 | Apr 6 2002 viewreview.jsp |
| -rw-r--r-- | 1 bob | 858 | Aug 9 00:19 waitforverify.jsp |
| -rw-r--r-- | 1 bob | 65 | Feb 19 2002 weblog.jsp |
| -rw-r--r-- | 1 bob | 2255 | Sep 4 14:59 whyrate.jsp |

./transpose/songsifter/jsps/includes:
total 43

| | | | |
|---|---|---|---|
| -rw-r--r-- | 1 bob | 1107 | Aug 8 20:27 announcement.jsp |
| -rw-r--r-- | 1 bob | 640 | Aug 8 20:27 autologin.jsp |
| -rw-r--r-- | 1 bob | 440 | Aug 8 20:27 beginbody.jsp |
| -rw-r--r-- | 1 bob | 229 | Aug 8 20:27 endbody.jsp |
| -rw-r--r-- | 1 bob | 2523 | Aug 8 20:27 footer.jsp |
| -rw-r--r-- | 1 bob | 9388 | Aug 8 20:27 header.jsp |
| -rw-r--r-- | 1 bob | 3646 | Aug 28 14:07 jspheader.jsp |
| -rw-r--r-- | 1 bob | 226 | Aug 8 21:19 notice.jsp |
| -rw-r--r-- | 1 bob | 785 | Aug 8 20:27 retrievepoints.jsp |
| -rw-r--r-- | 1 bob | 670 | Aug 8 20:27 setuppaging.jsp |
| -rw-r--r-- | 1 bob | 2151 | Aug 8 20:27 sidebarauctions.jsp |
| -rw-r--r-- | 1 bob | 442 | Aug 8 20:27 sidebarbadge.jsp |
| -rw-r--r-- | 1 bob | 974 | Aug 8 20:27 sidebardiscuss.jsp |
| -rw-r--r-- | 1 bob | 2228 | Aug 8 20:27 sidebarmailinglist.jsp |
| -rw-r--r-- | 1 bob | 1945 | Aug 8 20:27 sidebarmypoints.jsp |
| -rw-r--r-- | 1 bob | 3424 | Aug 8 20:27 sidebarsponsoredmusic.jsp |
| -rw-r--r-- | 1 bob | 2458 | Aug 8 20:27 sidebartopdailyscorers.jsp |
| -rw-r--r-- | 1 bob | 926 | Aug 8 20:27 sidebartopscorers.jsp |

./transpose/songsifter/logs:
total 0

| | | | |
|---|---|---|---|
| -rw-r--r-- | 1 bob | 0 | Aug 31 2001 turbine.log |
| -rw-r--r-- | 1 bob | 0 | Aug 31 2001 velocity.log |

./transpose/songsifter/mathjsps:
total 4

| | | | |
|---|---|---|---|
| drwxr-xr-x | 2 bob | 4096 | Oct 18 15:01 songdeed |

./transpose/songsifter/mathjsps/songdeed:
total 13

| | | | |
|---|---|---|---|
| -rw-r--r-- | 1 bob | 4984 | May 6 15:01 addsongdeedratings.jsp |
| -rw-r--r-- | 1 bob | 572 | May 6 15:01 |
| | | | processbackgroundsongratingcutoffs.jsp |
| -rw-r--r-- | 1 bob | 542 | Apr 1 2002 |
| | | | processdeedswithoutratings.jsp |
| -rw-r--r-- | 1 bob | 530 | May 6 15:01 processdirtysongratings.jsp |
| -rw-r--r-- | 1 bob | 901 | Mar 27 2002 reinitializeallmath.jsp |
| -rw-r--r-- | 1 bob | 512 | May 6 15:01 reinitializesongmath.jsp |
| -rw-r--r-- | 1 bob | 475 | Jun 19 09:36 resetallbest.jsp |
| -rw-r--r-- | 1 bob | 658 | May 17 11:24 |
| | | | testsongbackgroundinfo.jsp |
| -rw-r--r-- | 1 bob | 466 | Mar 1 2002 testwaitthread.jsp |

The code in these files has been tested to run on Sun Solaris 8, Resin 2.1.4 and Oracle 8i with interMedia installed. The code is supplied built with Ant, so Ant must also be available.

The steps for building and installing the system are:

1. Create an Oracle database named “ora8” and enable it for JDBC access according to the instructions from Oracle. In particular, the Oracle Listener needs to be running on port 1521 and the ctxsrv program should be running to keep the interMedia indexes up to date.

2. Use the commands in transpose/songsifter/database/OracleSchema.sql to create the database tables with the Oracle sqlplus program.

3. Build the code by running “ant” from the transpose/songsifter directory. It will create a new directory transpose/songsifter/build with the runnable object files.

4. Create a new web application named “songsifter” in resin/webapps/songsifter, where “resin” is the top directory for your Resin installation. Copy all of the files from the build directory created in the previous step into this new directory.

5. Ensure that the configuration file at resin/webapps/songsifter/WEBINF/conf/TurbineResources.properties file is properly configured for your configuration. In particular, you will need to change the definitions of

a. “database.default.url” to the appropriate address for your database server

b. “website.root” to the root address of the web application

c. “website.sitename” to the root address of the web site

d. “website.smtp” to the appropriate email server

e. “website.contactEmail” to the email address for contact information

f. “website.errorEmail” to the email address for error information

g. “website.blogID” and the other blog items to point to the web log that should receive updates from Emergent Music (or change these to empty definitions to turn blogging off).

6. Ensure that the configuration file at resin/webapps/songsifter/WEBINF/web.xml file is properly configured for your configuration. In particular you will need to change the definition for applicationPath

7. Start Resin

8. Access the songsifter/adminjsps/scheduledjobsjsp page to turn on the jobs that do background processing for the site.

### SUMMARY OF THE INVENTION

The present invention relates to data processing systems, and more particularly, recommender systems and systems that identify high-quality items. The items may be songs, URLs, news items, paintings, movies, TV shows, items of knowledge, etc. or any other item that may be of value to users of the system.

For historical reasons, the key objects in the system are referred to as “Deeds” (Dynamically Evolving Evangelical Descriptors). The type of digital objects referred to as Deeds are user-editable with associated ratings. Deeds may be, for example, wiki pages which have the ability to have associated ratings. (See http://c2.com/cgi/wiki?WikiWikiWeb for more on wikis.) However, for reasons of example, much of this description will focus on examples where the Deeds are descriptors, including reviews, of other items. In such examples, Deeds will identify the items (through descriptions, inclusion, links to the creators of the item, links to online descriptions or embodiments of the item, etc.). They will also contain reviews of the items (insights). If the item is good, and the review of it is well written (that is, it convinces people of the worth of the item) then the Deed is considered to be good. This is accomplished within the context of a client-server software system. In the current embodiment, represented by the accompanying code, the client is a standard Web browser operating on the Internet, the items are songs and the descriptions are reviews of those songs. Deeds are organized according to “Topics” which are based upon recommendations about particular items (songs in the current embodiment). Each Topic has a Current Best Deed that is the top-ranked Deed for that Topic.

Users of the invention have access to the Deeds and can read them and rate them. The display may take the form of a list or a tree structure showing all or some of the data from the Deeds, with access to the rest through a link. The system ranks which Deeds are good and causes them to appear near the top of a list or tree, making the good Deeds easier to access. As described below, Deeds may be created from other Deeds and the display may provide access to all of the versions, or as in the current embodiment, may show only one version of the Deed—usually the best or latest.

Any user can create a Deed (for a new Topic) or edit an existing Deed (creating a new Deed for an existing Topic). Users can also determine which Deeds are valuable and which are not. A Deed is valuable if it meets some or all of the following criteria:

a) The rating of the item (if there is a rating) is accurate

b) The insight is accurate

c) If the item is good, the insight tells why

d) If the item is good, but is not necessarily easily appreciated at first, the insight expresses that and, if appropriate, gives tips to enhance easier appreciation.

e) The insight is, in itself, a “good read”—that is, it is interesting and attractive, encouraging people to come back daily just to read the insights of the top Deeds,

f) The item itself is good.

g) The audience for the Deed is specified—not every item is of interest to every person, so the Deed should indicate who the target audience should be.

The list or tree of Deeds can display not only the summary information for the Deed, but it can also have links to the underlying item. For example, in the current embodiment, the Deeds have links that start the music playing and show the Deed information automatically. The list can be filtered to display Deeds that match a particular subset of the genres and a certain timeliness (such as up to one week old). Deeds and Topics can also be used to provide locations for discussions of the item or of the recommendation (the description of the item).

Each Deed can be copied in the hopes that it will be improved and gain a higher ranking. If a Deed is copied, the editor can change any descriptive field, but in preferred embodiments most or all fields are initialized to be the same as the parent Deed's. The user doing the improvement starts with the data last entered and can then edit as desired. The user must also provide a description of what was changed.

In order to display the list or tree of Deeds, the system must rank the Deeds to decide the order in which they should be displayed. The computations of the rankings can occur at intervals or when a new rating or vote comes in. The rankings can be computed through arithmetic averages, the Bayesian expectation of the next rating, voting, or some other method. It should not be construed that the scope of the patent is confined to particular methods of determining the community rating for each Deed.

In embodiments using ratings, the ratings are combined to form the community rating or ranking. Each Deed that is a revision of a previous Deed is given a slightly better rating than its predecessor if the person doing the editing has shown in the past that they have a likelihood of improving the Deed. This is done by a review of past edits to determine if they tended to have higher ratings than the Deeds that were edited. Providing the revision with a slightly better rating allows it to be shown to other users more easily so that it gets the ratings needed to determine if the changes really are improvements or not. If not, the rating of the new Deed decreases with the new ratings until its rating falls beneath the previous high-rated Deed for that Topic, which then supplants that new Deeds as the Current Best for that Topic (and so the version to show the user when he or she first encounters the Topic).

In each Topic, the Current Best Deed is shown—that is the one that is ranked the highest. In some embodiments, Topics exist within categories, so there are multiple lists in which Deeds can rise and fall. This involves separate processing of ratings within each such category. The current embodiment does not have that feature, but from the accompanying code, any programmer of ordinary skill in the art of programming can create such a system by storing ratings information separately for each category—for instance, in a database where the category is part of a concatenated key.

In some embodiments, ratings will only be permitted on the Deed that has been determined to be the Current Best for the Topic. When new ratings are processed, that Deed may be found to have a lower ranking than the second-best Deed. In this case, the second-best Deed becomes the new Current Best Deed and takes its appropriate place on the tree or list. Since it is now the Current Best, it will be the one that can now be rated. Similarly, it can be rated down and the next highest-rated Deed would take its place and so on, with the highest rated Deed always shown as the Current Best. So, even in a case where a malicious user creates a serious of undesirable edits, the Deed that is rated best by the community will return to the top of the list, tree, or Topic sub-tree.

If a Deed has no ratings yet, various schemes can be used to create a default rating. In preferred embodiments, the default rating is set to be a little better than the parent Deed (if it was copied) or to some default expectation for a new Deed (if it is created for a new Topic). However, other methods may be used, such as making the rating a little worse, or using a global constant that doesn't depend on the previous version, or using a population average rating. It should not be construed that the scope of the patent is confined to particular methods of setting the default rating.

When a Deed has few ratings, various schemes may be used to create a rating. The rating could be computed as the average of the default value and the actual rating values as if the default was another rating. Alternatively, the rating could be computed as (s*x+r1_+r2+ . . . +rn)/(s+n) where x is the default rating, s is the strength to be given that and r1 . . . rn are the 1st through nth rating. Similarly, a geometric mean could be calculated that uses the default as another rating or other ways can be used. It should not be construed that the scope of the patent is confined to particular methods of computing the rating from few actual ratings.

When a Deed has many ratings, one of the above approaches could be used and the values of the actual ratings would ultimately overwhelm the default value, or similar calculations can be done ignoring the default value.

In some embodiments, the decisions about ranking Deeds may rely on a vote among the users to determine whether a Deed or version of a Deed should be ranked higher or considered the Current Best. The vote may last a fixed period of time, may require a certain number of total votes, may require at least as many votes as a certain percentage of the user community, or rely on statistical or probabilistic means to determine when the voting is complete.

For instance, in some embodiments, a null hypothesis is assumed that a vote has a certain probability of being Yes. This may be a constant such as 50%, or may based on an analysis of votes in the population. Then, under the assumption that the null hypothesis is true, the probability that the current proportion of Yes votes, or a more extreme proportion, might have occurred is calculated. For example, any practitioner of ordinary skill in the art of probability could calculate the probability using the binomial distribution. If the computed probability is as extreme as or more extreme than a particular alpha-level such as 0.05, the vote is considered to be concluded and the appropriate action taken.

In conservative embodiments, it may be that an alpha-level of 0.05 must be reached in order for a Deed to be accepted as the new Current Best. Alternatively, in more freewheeling embodiments, it may be that the same alpha level must be reached to cause rejection. Of course, the meaning of “success” and “failure” in the “trials”, that is, the vote, would be adjusted to accommodate the intent of the embodiment.

In some embodiments voting would take a multi-valued rather than binary form. For instance, there might be 5 levels. The highest level, “Definitely use as the Current Best”, counts as 4 points and the lowest level counts as no points. Then the average points per user are calculated. Voting ends when a particular number of votes reached or a certain statistical confidence level is reached, according to the embodiment.

It should not be construed that the scope of the invention is limited to particular techniques for tabulating the votes and making decisions based on those tabulations.

The display of each Deed can also include the history of all Deeds for that Topic. This list provides access to any of the other Deeds and may also indicate the Deed, which is the Current Best, the Deed that most needs rating, and the other Deeds that need rating. In some embodiments the rating of the Deed is initialized to be the expectation of the ratings that will be accrued by a Deed that is cloned from another Deed with a particular rating. In preferred embodiments this is a Bayesian expectation where the prior knowledge is the rating of the parent.

As Deeds rise to higher levels of recognized quality, they can be added to lists of the best Deeds. These lists can be distributed in ways that are most interesting to the users of this information. In the current embodiment, this distribution consists of:

1. a weblog. Each item that reaches the critical level is automatically posted to the weblog. Users can browse the weblog, which is accessible from the Internet.

2. an XML feed. The weblog generates an XML, feed that users can subscribe to. This is a standard feature of blogging software, but it makes access to the list of top music much easier.

3. a “badge” with a pop-up list of the top rated songs. Web sites can place an icon and some JavaScript code on a web page so that when a user moves the mouse over the icon, a pop-up list appears displaying the best available songs. Other lists can easily be created as well, including the list of the latest changes, lists of the best song for a particular genre, etc.

4. M3U playlists. The lists of best music or latest changes can also be accessed as a playlist file that can be loaded into music player software so the user has access to the music in those Deeds automatically.

Users who have certain qualities including prescience (being able to predict how the population as a whole will rate the Deed) are considered better raters. Preferred embodiments reward the best raters, or “scouts”, according to how well they rate. In some embodiments, including the one in the accompanying code, this is done by giving them public credit in a list of the best raters and awarding them “points” that are redeemable to enable certain features. In the current embodiment, points can be used to provide advertising of favored bands or music, or to purchase music that is put up for “auction” for the most points. Each rater has a biographical page where people can see how well they rate.

However, in further preferred embodiments, another feature is added to reward users who are the best at rating. This is to pay them. Any programmer of ordinary skill in the art can access online payment systems to pay the best scouts, or it can be done manually by looking at the list of the best scouts and mailing them checks. The techniques for paying scouts will therefore not be spelled out in detail here, but one can access PayPal via xmlrpc to do so.

The best Authors of Deeds, in preferred embodiments, are also rewarded by similar means to those described for rewarding the best Scouts. The best Authors are those who create the Deeds that are rated the most highly.

Preferred embodiments provide a means to a) motivate individuals to donate money to be awarded to the Scouts and raters, and b) motivate Authors to create Deeds for songs that have been chosen by the donators, and Scouts to rate those Deeds.

In various embodiments different means can be used for the users to buy a position on lists of donators. In the accompanying code, this is based upon a bidding process, where people bid a certain amount of money or points, which goes toward a certain amount of time on the lists. There may be one list for bids of money and another list for bids of points. The bids with the most money or points buy the higher spots on the list. Some further embodiments combine bids for particular items (Topics, in the accompanying code), so that multiple entities can bid to put the same item high in the list, and these bids are summed into a single combined bid. Since, in the accompanying embodiment, bids are time-limited and can be made at any time, the combined bids for each item are recomputed every day, and the list is ordered from highest to lowest according to the summed bids for that day. However, many variants can be used to process the bids. It must not be construed that the invention is restricted to any particular bidding method. The overarching idea is that entities can bid money (or other valuable goods including, for instance, abstract credits) in order to position the item they are interested in high on the list so that Deeds will be created and/or rated with more priority relative to the position on the list.

Preferred embodiments spell out, for instance in an HTML text display, the idea that the list represents donations to the community, and therefore to increase the flow of donations, Scouts and Authors should pay special attention to Deeds related to the items in the list. This is accomplished by displaying a list of donations along with the items or Deeds or Topics associated with the item or items the donator wants to become better known. Note, another reason a donator might like to draw attention to a particular item would be as market research, to determine how well the public likes an item, in order to determine whether to using mass marketing to sell a product that contains it.

See the accompanying Computer Program Listing Appendix for the current embodiment.

Definitions

Deed, originally having meant “dynamically evolving evangelical descriptor,” now means a digital object representing information or knowledge of interest to human beings.

A Topic is an abstract entity having one or more associated Deeds. A Topic contains a key for locating related Deeds. Optionally it is associated with a text, visual or audio descriptor relating to the one or more Deeds associated therewith.

Having thus described the invention, what it is desired to claim and thereby protect by Letters Patent is:

1. A network-based computer system that organizes representations of information known as Deeds along with Topics associated therewith, wherein
Deeds associated with a given Topic represent different versions of the same document,
the system provides any of a plurality of users with the ability to create a new Deed by cloning, during which selected data is inherited from an existing Deed and some or all data may be edited,
the system provides a plurality of users with the ability to rate Deeds,
at any point in time, one Deed associated with a given Topic is considered to be the Current Best,
the system makes the Current Best more readily viewable than other Deeds associated with the Topic,
and the system combines expressions of opinion of a plurality of users to determine the Current Best.

2. The system of claim 1 wherein the system provides users with the ability to clone a Deed at any time.

3. The system of claim 1 wherein only the Current Best in a topic may be cloned at any given time.

4. The system of claim 1 wherein ratings of the quality or value of each item are derived from the opinions of a plurality of users.

5. The system of claim 4 wherein the ratings are collected through active means such as clicking an HTML radio button.

6. The system of claim 4 where ratings are collected through passive means such as monitoring how much time a user spends reading a Deed.

7. The system of claim 1 wherein the information is provided on a plurality of pages, the Current Best is visible by clicking on the name of a topic, and on the same page, links to other Deeds in the topic are available.

8. The system of claim 1 wherein the system makes available to be rated at any time only the Current Best.

9. The system of claim 1 wherein the system makes available to be rated at any time any Deed in a Topic.

10. The system of claim 1 wherein the system replaces the Current Best by a higher-rated Deed after a new rating or a change to an existing rating causes a different Deed to become the highest-rated one.

11. The system of claim 1 wherein the system replaces the Current Best by another one if the users so vote.

12. The system of claim 11 wherein voting is accomplished by compiling the opinions of a plurality of users.

13. The system of claim 12 wherein the most recent Deed automatically becomes the current Deed for the Topic unless voting causes it to be rejected for that role.

14. The system of claim 12 wherein the most recent Deed only becomes the Current Best for the Topic when voting has expressed a consensus view that this should occur.

15. The system of claim 12 wherein user interface features for voting relative to a Topic are presented only if one or more users express a desire that voting occur.

16. A method for organizing representations of information provided by users of a network-based computer system, such representations comprising dynamically evolving evangelical descriptors, known as Deeds, wherein
Deeds represent different versions of the same document, which includes communication such that a Topic may have a plurality of associated Deeds, comprising:
providing any of a plurality of users is the ability to create a new Deed by cloning, during which selected data is inherited from an existing Deed,
providing a plurality of users with the ability to rate Deeds,
wherein at any point in time, one Deed associated with a given Topic is considered to be the Current Best,
making the Current Best more readily viewable than other Deeds associated with the Topic, and
combining expressions of opinion of a plurality of users to determine the Current Best.

17. The method of claim 16, wherein a user is provided the ability to clone a Deed at any time.

18. The method of claim 16, wherein only the Current Best in a Topic may be cloned at any given time.
